(19) United States
(12) Patent Application Publication
(10) Pub. No.: US 2011/0247750 A1
(43) Pub. Date: Oct. 13, 2011

(54) REEL FOR USE WITH CABLE ELEMENTS

(75) Inventors: Ronald N. Kessler, Girard, OH (US); David M. Neill, Canfield, OH (US); Michael A. Hubicz, Orangeville, OH (US)

(73) Assignee: R&L MARKETING & SALES, INC., Boardman, OH (US)

(21) Appl. No.: 13/162,914

(22) Filed: Jun. 17, 2011

Related U.S. Application Data
(62) Division of application No. 12/486,150, filed on Jun. 17, 2009, now abandoned.
(60) Provisional application No. 61/073,410, filed on Jun. 18, 2008.

(51) Int. Cl. B29C 39/22

(52) U.S. Cl. 156/245

(57) ABSTRACT

A lightweight cable-dispensing reel assembled from two identical components, each manufactured from a single mold. The reel reduces the number of processes and parts used in the manufacturing process by providing a more efficient one-mold design which eliminates the use of screws, nuts, bolts, or bosses. A pair of identical side flange members are axially coupled together by a plurality of male and female snap connectors formed integrally on inwardly facing surfaces of the side flange members defining therebetween a cylindrical gap and hub for receiving a coil of wire. The snap connectors include a plurality of circumferentially spaced female connectors formed on a flange having an arcuate length of approximately 180 degrees. The arcuate flange circumferentially aligns with an identical arcuate flange on the other flange member when joined to form the wire supporting hub.

### CROSS REFERENCE TO RELATED APPLICATIONS

This application is a division of U.S. patent application Ser. No. 12/486,150, filed Jun. 17, 2009, which application claims priority from U.S. Provisional Application Ser. No. 61/073,410 filed Jun. 18, 2008; the disclosures of which are incorporated herein by reference.

### BACKGROUND OF THE INVENTION

1. Technical Field

The invention relates generally to reels for dispensing cables. More particularly, the invention relates to a lightweight cable-dispensing reel comprised of two identical one-piece members manufactured from a single mold and snap-fitted together.

2. Background Information

Wire dispensers and carriers upon which wires or wiring harnesses are mounted are well known in the art and are disclosed, for example, in U.S. Pat. Nos. 4,844,376 and 4,880,182. Wiring or cable has customarily been wound on reels comprising a cylindrical drum having flanges on opposite ends of the drum creating a reel. Typically, the reel is rotatably mounted on an axle and the user extracts cable by pulling the cable end. The force on the cable rotates the reel to unwind the cable.

Cable reels are made with many inner-connecting parts and are assembled in a lengthy process. Screws and bosses hold side flanges together and add to the overall weight of the reel. If reel elements are made from molded plastic, each distinct part requires a separate mold. As in any manufacturing process, the elimination of process steps reduces complexity and generally produces a more cost effective product.

Therefore the need exists for a cable reel that reduces the number of processes and parts used in the manufacturing process and thus provides a more efficient design.

### BRIEF SUMMARY OF THE INVENTION

It is therefore an object of the present invention to provide a reel for use with cable elements that reduces the number of processes and parts used in the manufacturing process. This and other objects are realized in accordance with the present invention by providing a side flange member that is axially coupled with another identical side flange member, defining therebetween a cylindrical gap and hub for receiving a coil of wire. The present invention has eliminated the nuts, bolts, screw, bosses or adhesives used in similar products to hold the two flange members together, and alternatively provides snap connectors integrated into the side flange members. One mold is required to form the entire product as two identical side flange members are combined to create the reel. Prototypes of the present invention have reduced the total price and weight by approximately one half, and have greatly decreased the overall manufacturing time.

### BRIEF DESCRIPTION OF THE SEVERAL VIEWS OF THE DRAWINGS

The preferred embodiment of the presented invention, illustrative of the best mode in which Applicant has contemplated applying the principals of the invention, is set forth in the following description and is shown in the drawings.

FIG. 1 is a perspective view of the assembled reel assembly;

FIG. 2 is an enlarged perspective view of the center elements of one of the side flange members;

FIG. 3 is a plan view of the inside surface of one of the side flange members;

FIG. 4 is an enlarged perspective view of one-half of the assembled reel with parts cut away;

FIG. 5 is an enlarged sectional view looking in the direction of line 5-5 of FIG. 4; and

FIG. 6 is a perspective view of the assembled reel assembly mounted on an axle and having wire wound thereon.

Similar numbers refer to similar parts throughout the drawings.

### DETAILED DESCRIPTION OF THE INVENTION

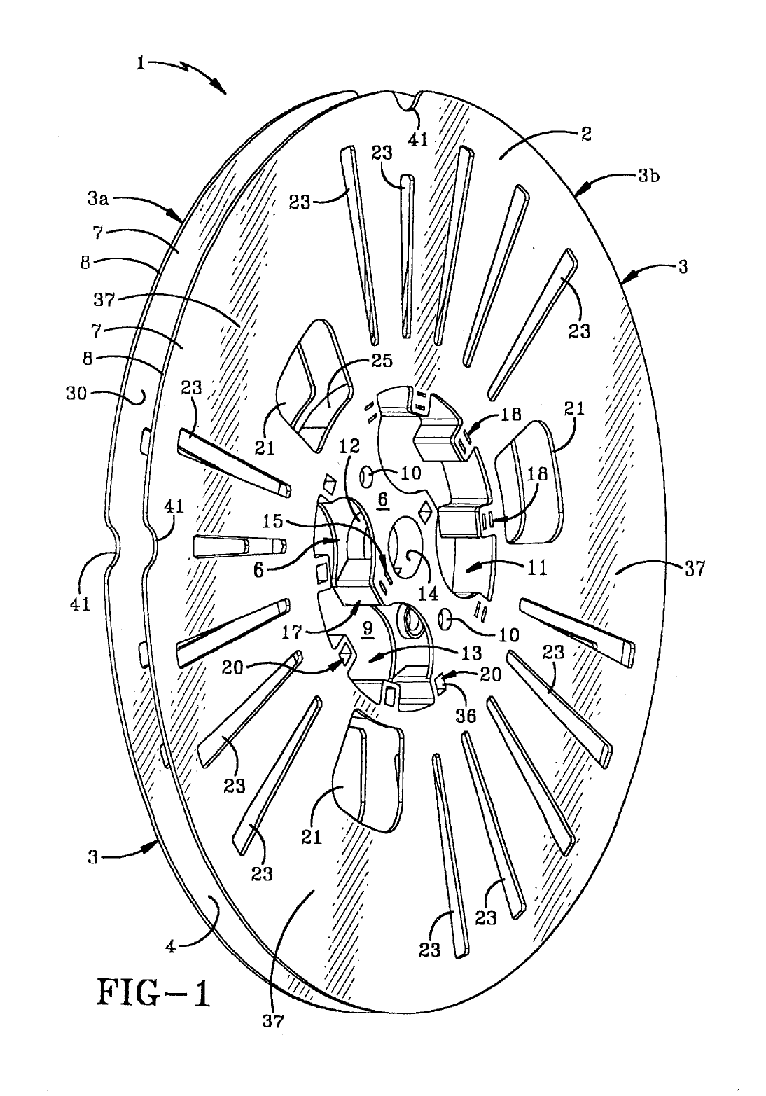

The reel assembly of the present invention which utilizes a single-mold and lightweight design is indicated generally at 1, and is shown in detail in FIGS. 1-6. As shown in FIG. 1, reel assembly 1 includes two identical side flange members 3, securely assembled together in a snap-fit engagement, each flange being a one-piece member cast from a single mold. Side flange member 3 includes an outward side 2 and an inward side 4, a circular rim portion 7 terminating in an outer circumferential edge 8 and a large central opening 9. Opening 9 is diametrically intersected by a bridge 6, creating a first side opening 11 and a second side opening 13.

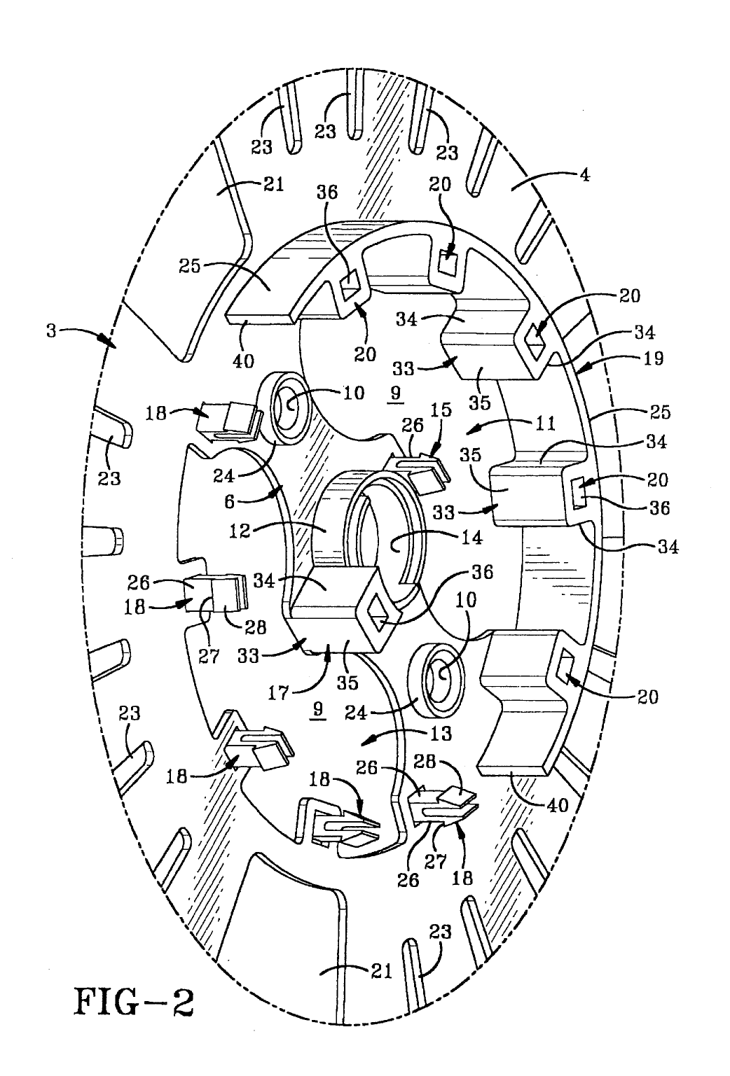

As illustrated in FIG. 2, a central hole 14 is formed in bridge 6 and is defined by a cylindrical stepped collar 12 extending outwardly from inward side 4 of side flange member 3. Bridge 6 also includes a pair of conventional drive holes 10 defined by projecting bosses 24 spaced apart on opposite sides of central hole 14. Bridge 6 also includes a male snap connector 15 and a female snap connector 17 spaced diametrically apart and on opposing sides of central hole 14. Male snap connector 15 extends outwardly from side 4 and is proximate first side opening 11, and female snap connector 17 extends outwardly from side 4 and is proximate second side opening 13.

Referring to FIGS. 2-5, spaced equidistant from one another and circumferentially around central hole 14 are five male snap connectors 18 and five corresponding female snap connectors 20. Male snap connectors 18 are proximate first side opening 13, and female snap connectors 20 are proximate second side opening 11. Snap connectors 18 and 20 are spaced and configured so as to snap-fit to corresponding opposite snap connectors 20 and 18 respectively, when two side members 3 have inward sides 4 facing each other and are pressed axially together after being rotated 180 degrees relative to one another. Male snap connectors 18 are identical to male snap connector 15.

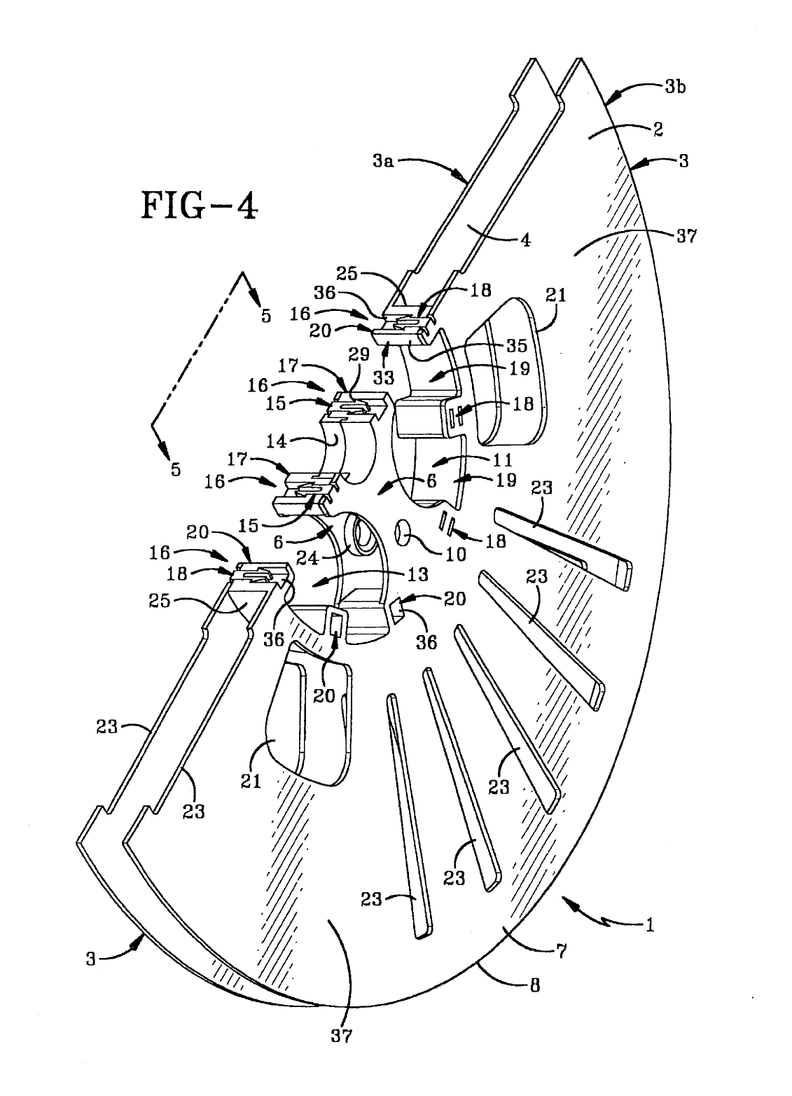

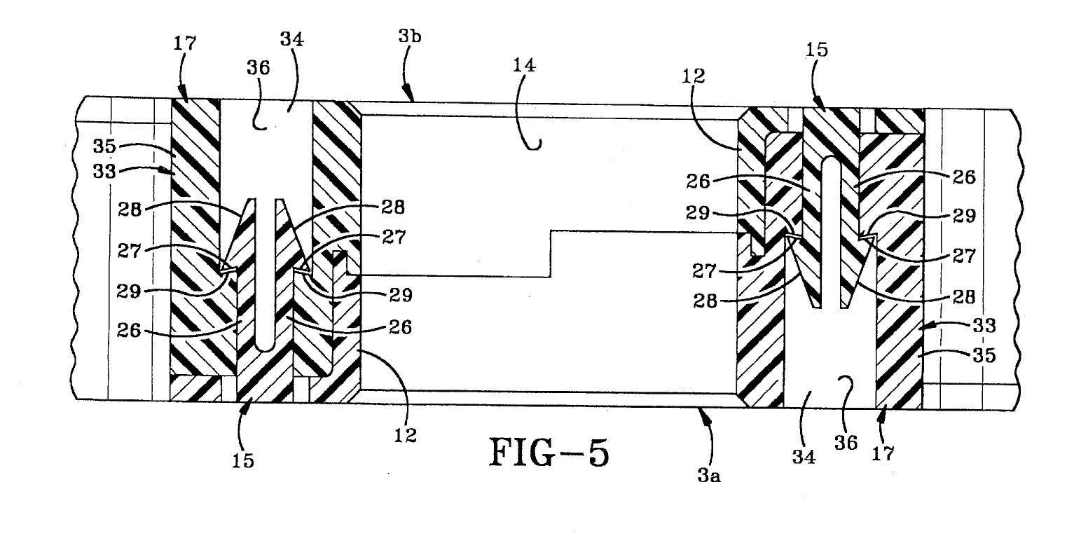

Shown in FIGS. 2 and 5, male snap connectors 15 and 18 each include two extending and spaced apart fingers 26, each with a shoulder 27 and a cam surface 28. Female snap connectors 20 are identical to female snap connector 17. As shown in FIGS. 4 and 5, snap connectors 20 are formed integrally with and extend radially inwardly from an arcuate hub wall section 19. Each female connector 20 includes a generally rectangular-shaped housing 33 having spaced side walls 34 and an outer end wall 35 which form a through aperture 36 having a shoulder 29 on the inner surfaces of side walls 34. Snap connector 17 is similar to snap connectors 20 except it is formed integrally with collar 12 of central hole 14 instead of being connected to hub wall section 19, and thus is not described in further detail. When male snap connectors 15 and 18 slidably engage with female snap connectors 17 and 20 respectively, cam surfaces 28 compress fingers 26 toward one another. As shoulders 27 move past shoulders 29, cam surfaces 28 terminate and allows fingers 26 to return to the default position. Shoulders 27 lock with shoulders 29 to prevent male snap connectors 15 and 18 from disconnecting from female snap connectors 17 and 20.

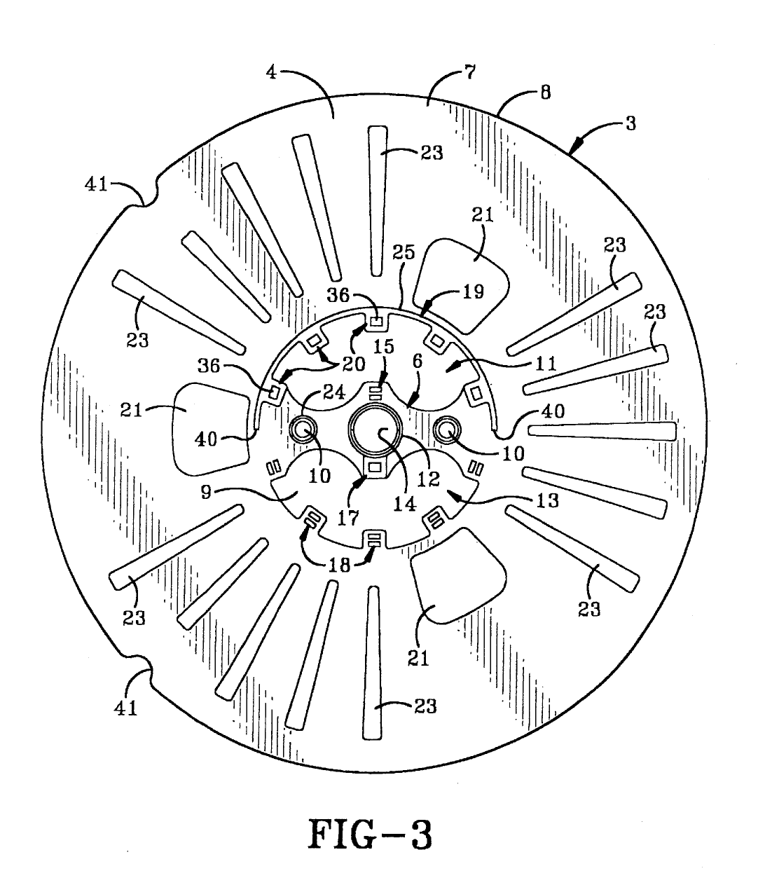

As illustrated in FIGS. 2-3, hub wall section 19 extends outwardly from inward side 4 of flange member 3 and has an arcuate length of approximately 180 degrees. Wall section 19 is circumferentially adjacent side opening 11 and forms a “half moon” shaped wall around approximately one half of side opening 11. As shown in FIG. 3, hub wall section 19 provides one of the plurality of walls forming each female snap connector 20, further reducing the amount of material required to fabricate reel assembly 1.

Side flange member 3 is formed with a plurality of openings or windows 21 and slits 23. As shown in FIG. 3, three generally rectangular shaped windows 21 are spaced evenly about and located generally proximate central hole 14 and are sized to allow a user to view the amount of remaining cable or wire on reel 1. Fifteen narrow and elongated slits 23 are spaced evenly in groups of five and are located generally proximate central hole 14 and extend radially outwardly. Slits 23 and windows 21 allow less material to be used in manufacturing side flange 3 and reduce the overall mass and weight of reel 1. Side flange member 3 also includes outer surface areas 37 adjacent windows 21 which are used to adhere labels (not shown) or information about the product contained on reel assembly 1.

As illustrated in FIG. 4, reel assembly 1 is very simply and easily assembled in accordance with the method of the present invention by placing two side flange members 3a and 3b symmetrically together with inward sides 4 of each side flange member 3 facing the other, and rotating one side flange member 180 degrees. This rotation aligns male snap connector 15 and female snap connector 17, as well as male snap connectors 18 and female snap connectors 20, into a complementary and locking position with one another, with male snap connectors 15 and 18 extending into apertures 36 of female snap connectors 17 and 20 and are held securely therein by the engagement of shoulders 27 and 29 as shown in FIG. 5. Side flange member 3a and 3b lock tightly and securely together forming a snap-fit connection therebetween, resulting from the joining of male snap connectors 15 and 18 and female snap connectors 17 and 20. When side flange members 3a and 3b combine, each side flange member provides a 180 degree hub wall section 19, which are circumferentially aligned with each other to form a 360 degree inner cylinder hub having an outer cylindrical wire or cable support surface 25.

When the side flange members are snap-fitted axially together the stepped configuration of collars 12 will seat within each other as shown in FIG. 5 to stabilize the interior of the reel in the area of central hole 14 through which an axle 32 or similar support extends for rotatably mounting reel 1.

It is also understood that the arcuate spacing between the male snap connectors will be the same as between the female snap connectors so that they align with the mating snap connectors of the axially opposed side flange member when oriented 180 degrees and pressed axially together.

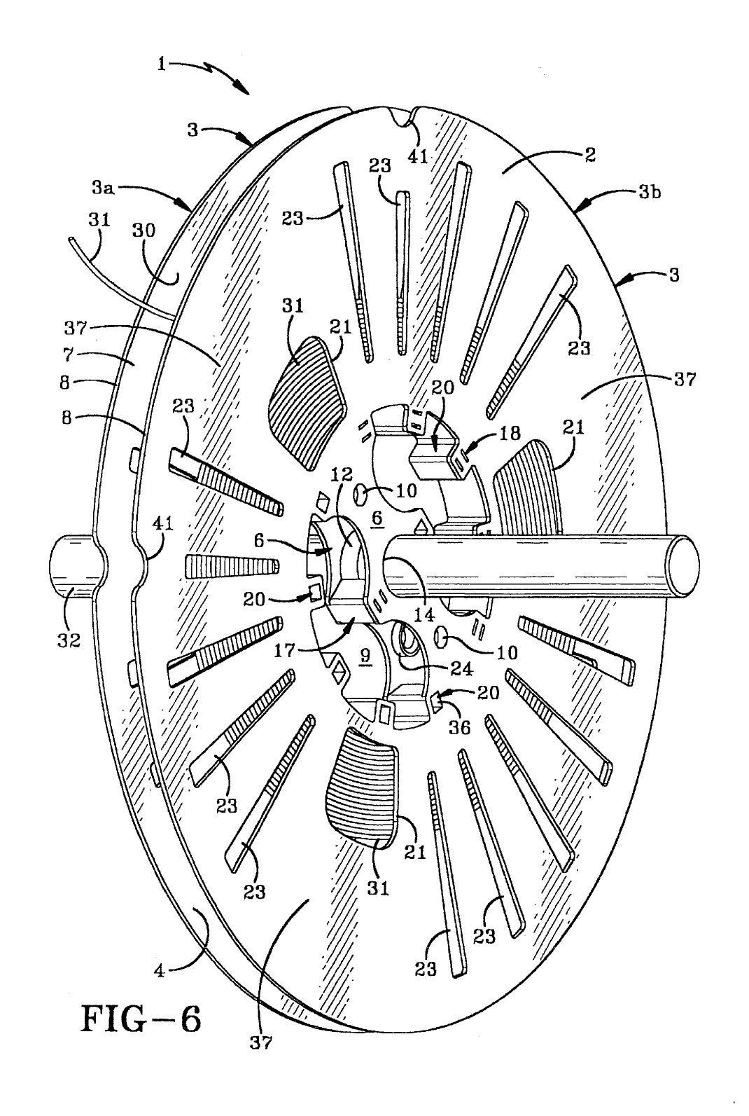

As shown in FIG. 6, a wire or cable 31 is wrapped around hub support surface 25, occupying a space 30 defined between inner sides 4 of side flange members 3 and is held securely therein resting on support surface 25 by the side flange members. Wrapping wire 31 around surface 25 and within space 30 allows a large amount of wire to be stored in a small space. To facilitate removal of wire 31, reel assembly 1 is rotatably mounted on axle 32, which extends through central hole 14. Typically support brackets (not shown) will extend through drive holes 10, allowing reel assembly 1 to rotate and spin about axle 32 as wire 31 is unwound and removed from the reel.

Side flange member 3 is a one-piece member typically manufactured or molded from conventional plastic. However, it is possible to manufacture flange members 3 from other materials such as rubber or other lightweight moldable material.

A particularly advantageous feature of reel assembly 1 is the simplified, low cost construction. The entire manufacturing process for forming reel assembly 1 requires a single mold for making one-piece side flange members 3. Two side flange members 3 are designed to fit together in a complementary but mirrored image style to form reel assembly 1. No additional materials are used in the construction of reel 1, which dramatically reduces complexity and weight. In place of nuts, bolts, screw, bosses or adhesives, male snap connectors 15 and 18, and female snap connectors 17 and 20, and the resulting snap-fit connection therebetween, provide an integrated attachment for securing two one-piece side flanges 3 together. Windows 21 and slits 23 in side flange member 3 reduce the amount of raw materials to produce reel assembly 1, which results in lower manufacturing cost and overall weight.

The width of hub support surface 25 is determined by the distance hub wall section 19 extends outwardly from side flange member 3. This distance is typically in the range of several inches to one foot, but is not limited to these dimensions. Manufacturers wishing to alter the width of hub support surface 25 will adjust the height of wall section 19, as well as the corresponding height of housings 33 which form female snap fasteners 17 and 20. Additionally, shoulder 29, cam surface 28 and flange 27 would be adjusted to create snap-fit connections at the appropriate distance from side flange member 3.

It is readily understood that the term cable or wire 31 could be other types of coiled material such as string, rope, tubing or other flexible materials readily stored on a reel for ease of shipment and dispensing and need not be limited to cable or wire as discussed above. Likewise, the number of windows 21 and slits 23 can vary without affecting the concept of the invention, as well as the use of side openings 11 and 13. Also, the number and location of the snap-fit connectors, both male and female, can also vary without affecting the concept of the invention. Again, the main feature of the invention is to be able to form a reel assembly by use of two identical one-piece side flange members, each of which contains a plurality of male and female snap connectors and a partial arcuate hub forming flange wall which when assembled are rotated approximately 180 degrees with respect to each other and then axially snap-fitted together. Also, it is understood that the arcuate length of hub wall section 19 could be less than 180 degrees, which would result in a gap between the terminal edges 40 of the hub wall sections. However, the preferred length of hub wall section 19 will be 180 degrees to provide for a continuous cylindrical surface 25 on which the cable is supported when wrapped about the formed hub. Furthermore, as indicated previously, each side flange member 3 can be molded of various types of plastic, elastomeric or even metallic materials although a high strength plastic provides the desired strength and flexibility to fingers 26 to facilitate the snap-fit connection between the male and female snap connectors. One or more positioning notches 41 may be formed in peripheral edge 8 to facilitate the dispensing of the wire cable from the reel as it is rotated.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method of manufacturing a reel comprising the steps of:
casting a first side flange member having an arcuate wall section and a plurality of snap connectors in a first mold;
casting a second side flange member substantially similar to the first side flange member in a second mold substantially similar to the first mold; aligning the arcuate wall sections of the first and second side flange members in a circumferential relationship to form a generally cylindrical hub surface; and
pressing the first and second side flange members axially together to interlock the snap connectors to fixedly secure together the first and second side flange members.

2. The method of manufacturing a reel as defined in claim 1, further comprising the step of forming the second side flange member as a one-piece member identical to the first side flange member.

3. The method of manufacturing a cable reel as defined in claim 1, further comprising the step of forming the snap connectors on the first flange member to include a plurality of female snap connectors and a plurality of male snap connectors; and forming a plurality of female snap connectors and a plurality of male snap connectors on the second flange member which axially align with the male and female snap connectors respectively on the first flange member when pressed axially together.

4. The method of manufacturing the reel as defined in claim 1, further comprising the step of fixedly securing the first side flange member to the second side flange member free of any screws, nuts, or bolts.

5. The method of manufacturing the reel defined in claim 1 including the step of forming the arcuate wall sections of the first and second side flange members with an arcuate length of approximately 180 degrees to provide a substantially 360 degree cylindrical hub surface.

6. The method of manufacturing the reel defined in claim 1 including the step of forming certain of the female snap connectors integral with the arcuate wall section.

7. A method of manufacturing a cable reel adapted to be formed from a single mold, comprising the steps of:
casting a first side flange member in the mold;
casting a second side flange member in the mold; and
fixedly attaching the first side flange member to the second side flange member.

8. The method of manufacturing a cable reel as defined in claim 7, further comprising the step of casting the first side flange member with a first partial center flange, and casting the second side flange member with a second partial center flange, and wherein the first partial center flange is complementarily aligned with the second partial center flange to provide a cylindrical surface adapted to axially support a cable or wire when the first side flange member is fixedly attached to the second side flange member.

9. The method of claim 7, further comprising the step of rotating the first side flange member 180 degrees to properly align the first side flange member and second side flange member prior to fixedly attaching the first side flange member to the second side flange member.

10. The method of claim 9, further comprising the step of disposing a plurality of male snap connectors on the first side flange member and the second side flange member.

11. The method of claim 10, further comprising the step of depressing a portion of each of the plurality of male snap connectors when the first side flange member and the second side flange member are fixedly attached thereto.

12. The method of claim 11, further comprising the step of depressing the portion of each plurality of male snap connectors when the first side flange member is fixedly attached to the second side flange member to allow the male snap connectors to release the first side flange member from the second side flange member.

13. The method of claim 12, further comprising the steps of:
casting a third side flange member in the mold; and
fixedly attaching the first side flange member to the third side flange member.

14. A method for forming a cable reel comprising the steps of:
forming a first side flange member with a first snap connector and a second snap connector;
forming a second side flange member with a third snap connector and a fourth snap connector;
rotating the first side flange member to align the first snap connector with the third snap connector on the second side flange member and align the second snap connector with the fourth snap connector on the second side flange member; and
pressing the first side flange member together with the second side flange member to lock the first snap connector with the third snap connector and the second snap connector with the fourth snap connector and thereby form the cable reel.

15. The method of claim 14, wherein the first snap connector includes two fingers defining a channel therebetween.

16. The method of claim 15, wherein each finger includes a generally flat cam surface and a shoulder extending inwardly therefrom.

17. The method of claim 16, wherein the second snap connector includes a rectangular-shaped housing having an inner surface and defining an entrance channel and a lock channel, and wherein a pair of shoulders are disposed at a junction between the entrance channel and the lock channel.

18. The method of claim 17, wherein the fourth snap connector is identical to the first snap connector and the third snap connector is identical to the second snap connector.

19. The method of claim 18, further comprising the steps of:
camming the fingers of the first snap connector towards one another to allow a top portion of the first snap connector to pass through the entrance channel of the third snap connector;
releasing the camming movement of the fingers when the top portion passes through the entrance channel and into the lock channel; and
abutting the shoulders of the first snap connector with the shoulders of the third snap connector to thereby secure the first side flange member to the second side flange member.

20. The method of claim 19, further comprising the steps of:
forming the entrance channel having a first cross-sectional width:
forming the lock channel having a second cross-sectional width; and
configuring the second cross-sectional width to be larger than the first cross-sectional width.
